(19) United States
(12) Patent Application Publication
(10) Pub. No.: US 2018/0047005 A1
(43) Pub. Date: Feb. 15, 2018

(54) DATA COLLECTION SYSTEM AND DATA TRANSFER DEVICE THEREOF

(71) Applicant: TRENDBOX BULUT BILISIM HIZMETLERI A. S., Istanbul (TR)

(72) Inventor: Ahmet BILGEN, Istanbul (TR)

(73) Assignee: Trendbox Bulut Bilisim Hizmetleri A.S., Istanbul (TR)

(21) Appl. No.: 15/553,673

(22) PCT Filed: Feb. 27, 2015
(86) PCT No.: PCT/TR2015/000078

§ 371 Date: Aug. 25, 2017

(51) Int. Cl. G06Q 20/20; G06F 13/42; G06F 13/38; G06F 1/28

(52) U.S. Cl. CPC G06Q 20/208; G06F 1/28; G06F 13/4286; G06F 13/385

(57) ABSTRACT

A data collection system includes a data transfer device which is attached between a data transmitter device and a data receiver device, takes a copy of the data instantaneously passing therebetween, sends the same to the cloud platform over the GPRS, and provides reporting of the data collected in the cloud platform. In particular, a data transfer device which is positioned to the retail points of sales, can collect sales information of the product instantaneously in the digital media, in the real time, is attached between the barcode reader and the computer/cash register/pos system, characterized by taking a copy of the data while the data read through the barcode reader is being transferred to the computer/cash register/pos system, sending the same to the cloud platform instantaneously and reporting the data collected in the cloud platform.

### TECHNICAL FIELD

The invention relates to a device which is developed so as to provide the sales data of the retail industry to be reportable instantaneously in the digital media, in the real time and to provide taking the general picture of the sector, appeals to the retail industry and the FMCG industry (Fast Moving Consumer Goods, also known as Consumer Packaged Goods).

The invention especially relates to a system which is positioned to the retail points of sales, collects sales information of the product from the points of sales, blends this information with the very important data such as potential customer data, weather condition, and social activities, and provides real-time smart reports.

### STATE OF THE ART

In the current retail market, the use of a device which is similar to the device according to the invention is not available. For this reason, the retail firms cannot analyze the data at the point where the data is composed. This means that the very important data for the serving persons or institutions cannot be stored and analyzed.

The companies which can analyze the data at the point where the data is composed have a great advantage over their rivals and can provide the best service to their customers. To have this ability, the companies are required to make information technology investments with higher costs, to accommodate and train expert human resources and to adapt them to the current developments.

In the prior art, research companies can be used for collecting and analyzing the data in the retail, industry. However, the research companies demand high costs for collecting and analyzing these data. Moreover, collecting and analyzing the data is not instantaneous and performing said processes requires a specific time period. Taking the requirement that a lot of parameters be observed instantaneously in the retail industry into consideration, the analysis made by the research companies means not only high costs but loss of time as well.

The fact that the research companies form a monopoly In the market and demand high sum of money also create an important cost burden on the firms in the retail industry.

It becomes more difficult day by day to take the pulse of the retail industry as it is spread to a wide area and majority of the industry has an unorganized (traditional retail) structure, A platform which will report the entire retail data instantaneously is not available in the state of the art.

Having been encountered as a result of the technical researches, the Application No. US20140368118 relates to a cloud-based logging service. Another application which has been encountered as a result of the technical researches is the U.S. Pat. No. 8,799,413B2 which relates to a system that distributes data for a distributed file system across multiple cloud storage systems. However, neither of the applications have a novelty which aims to solve the aforementioned drawbacks.

To conclude, due to the drawbacks mentioned above and the inadequacy of the existing solutions, a development is deemed necessary to be made in the related technical field.

### OBJECTS OF THE INVENTION

The invention, configured by being inspired by the current conditions, aims to solve the above mentioned drawbacks.

The primary object of the invention, so as to eliminate the aforementioned disadvantages and offer new advantages to the related technical field, is to provide a system which is positioned to the retail points of sales, collects sales information of the product from the points of sales, blends this information with the very important data such as potential customer data, weather condition, and social activities, and provides real-time smart reports, and to provide a device for this system.

Another object of the invention is to develop a device which appeals to any firm in the retail industry intending to obtain instantaneous sales data, eliminates both the monopoly of the research companies and the requirement to pay the high costs demanded.

Another object of the invention is to prepare the production plans of the companies together with the instantaneously collected data of the products sold in the market and to minimize the production planning errors.

Another object of the invention is to eliminate the high costs paid to the research companies and the time required for waiting for reaching to the requested data, thereby relieving the firms of this great financial loss.

Another object of the invention is to take the data from the point it is composed (payment point) with the cloud technology and to provide the data become significance with the real time for the retail industry. The device according to the invention is configured with the aim of being a platform which will report the entire retail data instantaneously.

Yet another object of the invention is to instantaneously present the transparent, objective and real data not convenient to be manipulated, to the all private sector and public institutions by complying with the existing regulations.

One of the most important objects of the invention is to make the big data to become significant with the external factor parameters on the cloud technology in a real time (instantaneous) and a very fast manner using the device according to the invention and to report all the information together. It is a great novelty in the sector to collate the sales reports required by the retail industry with the real-time, fast and multidimensional parameters (rival, weather, real-time potential customer data, organization calendars, etc.) at the point where the data is composed and to provide ease of deciding for the managers. One of the most important differences of the system according to the invention is to provide the information such as instantaneous product sales information, instantaneous potential customer data, instantaneous weather condition, instantaneous social activity information, etc. to be accessed instantly.

The general object of developing the device according to the invention is to facilitate controlling of the retail industry. In brief, the following objects will be achieved with the device according to the invention:
Collecting the sales data composed by the retail industry with a method not available so far.
Increasing the service presented by adding the data such as weather condition, activity, and smart map to the data collected.
Reporting this big data set composed in a real time manner with the requested filter and parameters rapidly.
Reporting the big data with the external factor parameters on the cloud technology in a real time (instantaneous) and a very fast manner.

To achieve the aforementioned objects, the invention is a data storage system comprising a data transfer device which is attached between a data transmitter device and a data receiver device, takes a copy of the data instantaneously passing therebetween, sends the same to the cloud platform, and provides reporting of the data collected in the cloud platform, wherein said data transfer device comprises
a central processing unit which functions as brain and manages all the administration, control, communication and inspection processes;
a communication unit which provides the data coming from the data transmitter device to be transferred to the cloud platform instantaneously upon the communication of the data transfer device with the cloud platform;
at least two connection ports which provide the connection of the data transmitter device and the data receiver device with the data transfer device;
power input which provides the energy input required for the operation of the data transfer device.

The structural and characteristic features and all the advantages of the present invention will be more clearly understood thanks to the figures below and the detailed description written with reference to those figures, therefore; the evaluation needs to be done by taking said figures and the detailed description into consideration.

### FIGURES FOR A BETTER UNDERSTANDING OF THE INVENTION

FIG. 1 is the schematic view of the data transfer device according to the invention.

FIG. 2 illustrates the system comprising the data transfer device according to the invention.

FIG. 3 illustrates the embodiment of the data transfer device according to the invention realized with the POS system.

FIG. 4 illustrates the embodiment of the data transfer device according to the invention realized with many POS systems.

The drawings do not need to be scaled and the details that are not necessary for understanding the present invention may have been ignored. In addition, the elements that are at least identical to a great extent or at least have identical functions to a great extent are referred with the same number.

### DESCRIPTION OF THE PART REFERENCES

1. Data transfer device
2. Central processing unit
3. Communication unit
   31. GPRS modem
   32. Sim card
   33. GSM antenna
6. Active port option switch
7. Power input
8. Operation indicator
9. Communication indicator
10. Power indicator
11. Data receiver device
12. Data transmitter device
   121. Barcode reader
13. Connection port
   131. RS232 output port
   132. RS232 input port
   133. USB input port
   134. USB output port
   135. PS2 input port
   136. PS2 output port
   137. 9E/RS485 input port
   138. 9E/RS485 output port
14. 9E/RS485 adapter
15. Cloud platform

### DETAILED DESCRIPTION OF THE INVENTION

In this detailed description, the preferred embodiments of the invention are described only for a better understanding of the subject without any limiting effect.

The invention is a data storage system comprising a data transfer device (1) which is attached between a data transmitter device (12) and a data receiver device (11), takes a copy of the data instantaneously passing therebetween, sends the same to the cloud platform (15) over the GPRS, and provides reporting of the data collected in the cloud platform (15).

In the preferred embodiment of the invention, the data transmitter device (12) is a barcode reader (121) reading the barcodes on the products and the data receiver device (11) is a cash register or a computer or POS (point of sale) system. The device according to the invention is a data transfer device (1) which is positioned to the retail points of sales, can collect sales information of the product instantaneously in the digital media, in the real time, is attached between the barcode reader (121) and the computer/cash register/pas system, wherein it provides taking a copy of the data while said data read through the barcode reader (121) is being transferred to the computer/cash register/pos system, sending the same to the cloud platform (15) instantaneously and reporting the data collected in the cloud platform (15). This reporting process is performed such that the data collected in the cloud platform (15) is collated with the external factor parameters (potential customer data, weather condition, social activity information, GSM operator signal data, smart map, etc.) and the smart reports are prepared in a real time manner with the requested filter and parameters.

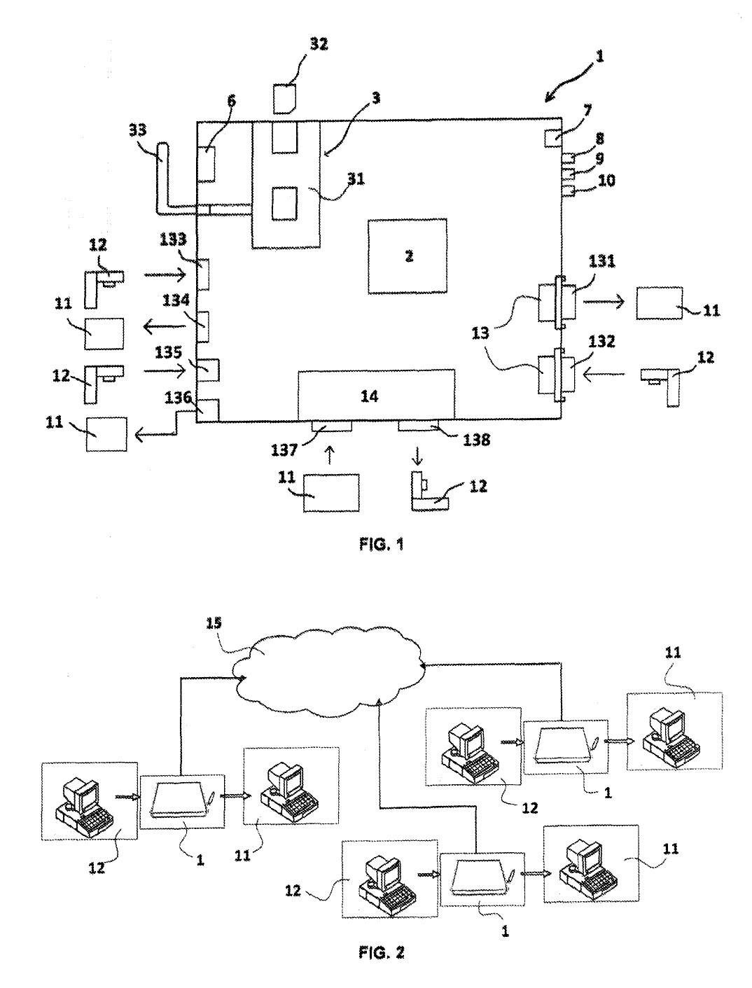

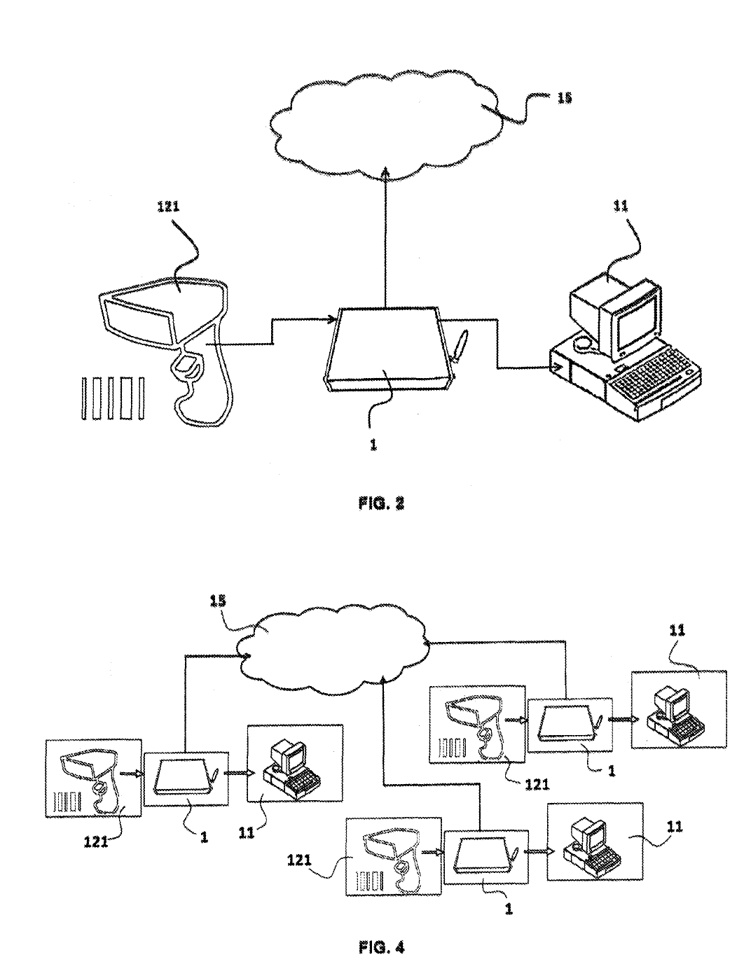

The data transfer device (1), the schematic view of which is given in FIG. 1 comprises
a (32 bit) central processing unit (2) which functions as brain and manages all the administration, control, communication and inspection processes;
a communication unit (3) which provides the data coming from the data transmitter device (12) to be transferred upon the communication of the data transfer device (1) with the cloud platform (15);
at least two connection ports (13) which provide the connection of the data transmitter device (12) and the data receiver device (11) with the data transfer device (1);
power input (7) which provides the energy input required for the operation of the data transfer device (1).

In the preferred embodiments of the invention, said communication unit (3) comprises
a dual band GPRS modem (31) which operates between 900-1800 MHz and provides the data coming to the data transfer device (1) to be sent to the cloud platform (15);
a sim card (32) which is located on the GPRS modem so as to provide communication;
a GSM antenna (33) positioned on the device, which provides the wireless communication of the data transfer device (1) with the external environment.

In the preferred embodiments of the invention, said connection ports (13) positioned on the outer surface of the data transfer device (1) are
at least one RS232 input port (132),
at least one USB input port (133),
at least one PS2 input port (135),
at least one 9E/RS485 input port (137),
   which provide data transmission from the data transmitter device (12) (preferably barcode reader (121)) to the data transfer device (1);
at least one RS232 output port (131),
at least one USB output port (134),
at least one PS2 output port (136),
at least one 9E/RS485 output port (138),
   which provide data transmission from the data transfer device (1) to the data receiver device (11) (preferably computer/cash register/pos system).

A 9E/RS485 adapter (14) is positioned into the device, which provides the communication of the 9E/RS485 input and output ports (137, 138) with the device over the 9E/RS485 communication protocols. 9E/RS485 input and output ports (137, 138) are connected to the data transfer device (1) over said 9E/RS485 adapter (14).

An active port option switch (6) is available which is positioned into the device so as to select the desired one from all the data transmitter devices (12) connected to said connection ports (13). With the additional hardware to be added to the data transfer device (1), the data transfer device (1) can transfer data between multiple data transmitter and receiver devices (12, 11) simultaneously.

The data transfer device (1) operates with 12V DC current and this current is supplied to the device through a power input (7). Three LED indicators are available which are placed adjacently at the side sections of the outer surface of the data transfer device (1). These are the operation indicator (8) showing that the device operates problem-free, the communication indicator (9) showing that the communication function is achieved, and the power indicator (10) showing that the energy required by the device is supplied. The user has the information about the operation condition of the data transfer device (1) by looking at these LED indicators.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A data collection system for use with the retail points of sales, the data collection system comprising:
at least one data transmitter device;
at least one data receiver device;
at least one data transfer device configured to take a copy of data instantaneously passing between the at least one data transmitter device and the at least one data receiver device; and
a cloud platform, wherein the data transfer device is configured to send the data instantaneously to said cloud platform in order to provide reporting of the data collected in the cloud platform, wherein the data transfer device comprises:
a central processing unit configured to manage administration, control, communication and inspection processes;
a communication unit configured to provide the data coming from the data transmitter device to be transferred to the cloud platform instantaneously upon communication of the data transfer device with the cloud platform;
at least two connection ports configured to connect of the data transmitter device and the data receiver device with the data transfer device; and
a power input configured to provide energy input required for operation of the data transfer device, wherein the at least one data transmitter device is a barcode reader.

18. The data collection system of claim 17, wherein the communication unit comprises:
a GPRS modem configured to provide data copied by the data transfer device to be sent to the cloud platform; and
a sim card configured to provide communication wherein the sim card is located on said GPRS modem.

19. The data collection system of claim 18, wherein said GPRS modem is a dual band modem operating between 900-1800 MHz.

20. The data collection system of claim 17, wherein the communication unit comprises a GSM antenna configured to provide wireless communication between the data transfer device with an external environment.

21. The data collection system of claim 17, wherein the data receiver device is a cash register or a computer or a POS system.

22. The data collection system of claim 17, wherein the data collection system is configured to blend data copied by the data transfer device with external parameters.

23. The data collection system of claim 22, wherein the external parameters are potential customer data, weather condition data, social activity information, GSM operator signal data, and smart map data.

24. The data collection system of claim 17, wherein the connection ports are positioned on an outer surface of the data transfer device, the connection ports comprise at least one RS232 input port which provides data transmission from the data transmitter device to the data transfer device and at least one RS232 output port which provides data transmission from the data transfer device to the data receiver device.

25. The data collection system of claim 17, wherein characterized in that the connection ports are positioned on the outer surface of the data transfer device, the connection ports comprising at least one USB input port which provides data transmission from the data transmitter device to the data transfer device and at least one USB output port which provides data transmission from the data transfer device to the data receiver device.

26. The data collection system of claim 17, wherein the connection ports are positioned on the outer surface of the data transfer device, the connection ports comprising at least one PS2 input port which provides data transmission from the data transmitter device to the data transfer device and at least one PS2 output port which provides data transmission from the data transfer device to the data receiver device.

27. The data collection system of claim 17, wherein the connection ports are positioned on the outer surface of the data transfer device, the connection ports comprising at least one 9E/RS485 input port which provides data transmission from the data transmitter device to the data transfer device and at least one 9E/RS485 output port which provides data transmission from the data transfer device to the data receiver device.

28. The data collection system of claim 17, wherein the data transfer device comprises a 9E/RS485 adapter which provides communication of 9E/RS485 input and output ports with the data transfer device over 9E/RS485 communication protocols.

29. The data collection system of claim 17, wherein the data transfer device comprises an active port option switch which selects a desired one from all the data transmitter devices connected to the connection ports.

30. The data collection system of claim 17, further comprising:
an operation indicator showing that the data transfer device operates problem-free.

31. The data collection system of claim 17, further comprising:
a communication indicator showing that communication functions of the data transfer device are achieved.

32. The data collection system of claim 17, further comprising:
a power indicator showing that energy required by the data transfer device is supplied.
